(19) United States
(12) Patent Application Publication
(10) Pub. No.: US 2010/0035079 A1
(43) Pub. Date: Feb. 11, 2010

(54) HIGH-STRENGTH COLD-ROLLED STEEL SHEET AND METHOD FOR MANUFACTURING THE SAME

(75) Inventors: Kohei Hasegawa, Tokyo (JP); Tadashi Inoue, Tokyo (JP); Takamasa Kawai, Tokyo (JP); Yukio Kimura, Tokyo (JP)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: JFE STEEL CORPORATION, Tokyo (JP)

(21) Appl. No.: 12/527,879

(22) PCT Filed: Dec. 14, 2007
(86) PCT No.: PCT/JP2007/074592

§ 371 Date: Aug. 20, 2009

(30) Foreign Application Priority Data
Mar. 1, 2007 (JP) 2007-051005

(51) Int. Cl. B32B 3/30; B21B 1/22; B21B 23/00

(52) U.S. Cl. 428/600; 72/247; 72/366.2

(57) ABSTRACT

A high-strength cold-rolled steel sheet having a tensile strength of 340 MPa or more, which can prevent galling, can be manufactured even if a large number of the steel sheets are continuously press-formed. This is because a surface texture thereof is con-trolled so that the surface texture includes flat areas in which a roughness profile has a deviation of ±2 μm or less from a filtered waviness curve and a dented portion having a maximum depth between 10 μm and 50 μm from the filtered waviness curve, wherein an average area of the dented portion is more than 0.01 mm² and 0.2 mm² or less, and an area fraction of the dented portion relative to the entire surface thereof is 5% or more and less than 20%.

### RELATED APPLICATIONS

This is a §371 of International Application No. PCT/JP2007/074592, with an international filing date of Dec. 14, 2007 (WO 2008/108044 A1, published Sep. 12, 2008), which is based on Japanese Patent Application No. 2007-051005, filed Mar. 1, 2007.

### TECHNICAL FIELD

This disclosure relates to a high-strength cold-rolled steel sheet with excellent galling-prevention properties, in particular, to a high-strength cold-rolled steel sheet having a tensile strength (TS) of 340 MPa or more and enhanced galling-prevention properties obtained by controlling steel surface texture and a method for manufacturing the same.

### BACKGROUND

A cold rolled steel sheet is generally formed into a desired shape by press-forming and is widely used as an automobile part, an electric appliance part, or the like. If a large number of cold rolled steel sheets are continuously press-formed, galling will occur by increased sliding friction caused by metal transfer between a stamping tool and the cold rolled steel sheet. Consequently, damage of the stamping tool or defects in stamping parts may occur in press-forming due to the galling. Particularly, when a high strength steel sheet is used, which has been increasingly used in recent years because it can reduce the weight of the parts, galling easily occurs due to high contact pressure applied to the high strength steel sheet with the stamping tool at press-forming. With respect to this situation, several methods are suggested to prevent the occurrence of the galling. Examples of the methods include methods of controlling properties of materials of a steel sheet and the stamping tool, steel surface texture (geometric texture), and the condition of an oxide film on the surface of the steel sheet and a method of optimizing viscosity of a lubricant and a method of work-hardening the surface of the steel sheet.

Among the above-mentioned methods, a method of controlling the steel surface texture has been studied because, if the method is applied, the intrinsic formability of the steel sheet can remain and an additional step for manufacturing is not needed. For example, Japanese Unexamined Patent Application Publication No. 2-163344 discloses a method of controlling a fraction of swelling areas on the surface of the steel sheet relative to the entire surface thereof to be 20% to 60% and an average area per swelling to be 2×10⁴ to 10⁵ [μm²]. Japanese Unexamined Patent Application Publication No. 2-163345 discloses a method of controlling surface roughness SRa of the steel sheet to satisfy the following inequality condition, Sra≧(32.4/YS [kgf/mm²])-1.1, where YS is a yield stress. Japanese Unexamined Patent Application Publication Nos. 5-261401, 6-218403, 6-87001, 6-87002, 6-87003, 6-91305, and 6-116745 disclose methods of controlling dented portions on the surface of the steel sheet to have a depth of 0.5% to 10% of the thickness thereof, a total volume thereof to be 0.8×10⁶ μm³ or more per 1 mm² of the surface, and a total area thereof to be 0.2 mm² or more, and furthermore, arranging various layouts of dented portions (dented areas). Japanese Unexamined Patent Application Publication No. 9-29304 discloses a method of providing the dented portions having a depth of 10 to 30 μm measured from the surface of flat portions (flat areas), the flat area having an average roughness Ra of 0.2 to 0.4 μm and further controlling each of dented areas to be 0.0001 to 0.01 mm² and the (total) fraction thereof to be 5% to 30%.

At the same time, after a coating, step, to enhance distinctness, a method of controlling a steel surface texture is also suggested. For example, Japanese Unexamined Patent Application Publication No. 63-111156 discloses a method of controlling flatness P of the swelling on the surface thereof to be 0 to 0.2 and an average maximum profile valley depth Rv to be 0.1 μm or more. Japanese Unexamined Patent Application Publication No. 6-91303 discloses a method of controlling the average waviness Wca and average roughness Ra of the surface of the steel sheet each to be 0.6 μm or less, a fraction of flat areas, which has a ten-point-height of irregularities Rz of 3 μm or less, relative to the entire surface thereof, to be from 20% to 80%, and the shortest distance between dented portions having a depth of 2 μm or more to be from 10 to 200 μm. Japanese Unexamined Patent Application Publication No. 6-210364 discloses a method of controlling the average waviness of the steel surface to be 0.6 μm or less, a ten-point-height of irregularities of a punch surface to be 10 μm or more, the average roughness Ra of a die surface to be 0.4 μm or more, and area fraction of flat portions relative to the entire surface thereof to be 40% or more. Japanese Unexamined Patent Application Publication No. 9-118918 discloses a method of controlling the average roughness Ra of the steel surface to be 0.8 μm or less, maximum roughness Rmax thereof to be 4.0 μm or less, and a ratio of Rv/Rmax to be 0.7 or less. Here, Rv is the maximum profile-valley-depth. Japanese Unexamined Patent Application Publication No. 10-24301 discloses a method of controlling the maximum roughness Rmax thereof to be 4.0 μm or less and the ratio of Rv/Rmax to be 0.6 or more.

Note that, to evaluate galling characteristics that are described below in the Examples, an apparatus described in Japanese Unexamined Patent Application Publication No. 2005-240148 was used.

However, since some methods described above are directed to mild steel sheets, if the methods are applied to high-strength steel sheets which are formed using a stamping tool under high contact pressure in press forming, in particular, in the case that the steel sheet used is a high-strength cold-rolled, steel sheet having a tensile strength of 340 MPa or more, occurrence of galling cannot be always prevented. Also, some methods cannot effectively control the occurrence of galling in similar high-strength steel sheets that are to be subjected to high contact pressure.

It could therefore be helpful to provide a high-strength cold-rolled steel sheet having a tensile strength of 340 MPa or more and a method of manufacturing thereof in which galling is certainly prevented from occurrence if cold-rolled steel sheets are consistently press-formed.

### SUMMARY

We thus provide a high-strength cold-rolled steel sheet characterized in that the steel sheet has a surface (geometric) texture thereon including flat portions in which a roughness profile (steel surface profile) has a deviation of ±2 μm or less from a filtered waviness curve and dented portions having a maximum depth between 10 μm and 50 μm from the filtered waviness curve, wherein the average area of the dented portions is more than 0.01 mm² and 0.2 mm² or less, and an area fraction of the total of the dented portions is 5% or more and less than 20%.

The high-strength cold-rolled steel sheet can be manufactured by the method of manufacturing thereof having excellent galling-prevention properties, the method including steps of cold-rolling a steel sheet after hot rolling and annealing a resulting cold rolled steel sheet, wherein, in the cold rolling step, a cold rolling of a rolling reduction rate of 5% or more is performed using a work roll having maximum profile peak height Rp of 10 μm or more and 50 μm or less and core roughness depth Kernrauhtiefe (DIN4776-1990) Rk of 10 μm or more of the surface of the work roll.

The high-strength cold-rolled steel sheet can also be manufactured by the method of manufacturing thereof having high galling-prevention properties, the method including steps of cold-rolling a hot rolled steel sheet and annealing a resulting cold rolled steel sheet, wherein, after the annealing step, temper rolling of an elongation rate of 0.10% or more is performed using a work roll having maximum profile peak height Rp of 10 μm or more and 50 μm or less and Kernrauhtiefe Rk of 10 μm or more of the surface of the work roll.

### BRIEF DESCRIPTION OF THE DRAWINGS

FIG. 1 is a schematic view of a roughness profile (steel surface profile) and a filtered waviness curve of a steel surface;

FIG. 2 is a schematic view illustrating a method of measuring maximum profile peak height Rp;

FIG. 3 is a schematic view illustrating a method of measuring Kemmauhtiefe Rk; and

FIG. 4 is a topographic image showing an example of measurement results (the relationship between a depth and a color tone) observed under a scanning electron microscope with a 3-dimensional surface texture analyzer.

Reference numerals are as follows:
1 roughness profile (steel surface profile)
2 filtered waviness curve
3 curve showing “filtered waviness curve 2+2 μm”
4 curve showing “filtered waviness curve 2−2 μm”
5 dented portion
6 roughness profile (filtered)
7 centerline of filtered roughness profile
8 a highest point of filtered roughness profile within a sampling range
9 roughness profile after specific filtering
10 bearing area curve
11 minimum-gradient line
12 flat area (SEM image)
13 dented area (SEM image)

### DETAILED DESCRIPTION

### (High-Strength Cold-Rolled Steel Sheet)

### (Surface Texture)

Galling-prevention properties during press forming can be improved by holding a lubricant in dented portions on a steel surface of a steel sheet so as to prevent metal transfer between a stamping tool and the steel sheet. For a high-strength cold-rolled steel sheet, however, if the high-strength cold-rolled steel sheet has a similar surface texture to an existing mild steel sheet, the galling-prevention properties thereof cannot be improved because microscopic plastic deformation generated in press forming of the surface thereof is smaller than that of the mild steel sheet and contact pressure applied thereto by the stamping tool is significantly higher than that applied to the mild steel sheet.

We, however, found that the occurrence of galling is prevented with certainty if a high-strength cold-rolled steel sheet has a surface (geometric) texture including flat portions in which roughness profile (steel surface profile) having a deviation of ±2 μm or less from a filtered waviness curve and dented portions having a maximum depth between 10 μm and 50 μm from the filtered waviness curve, wherein the average area of the dented portions is more than 0.01 mm² and 0.2 mm² or less, and the fraction of the total area of the dented portions is 5% or more and less than 20%. This is described in detail as follows.

1) Presence of flat portions in which roughness profile has a deviation of ±2 μm or less from a filtered waviness curve

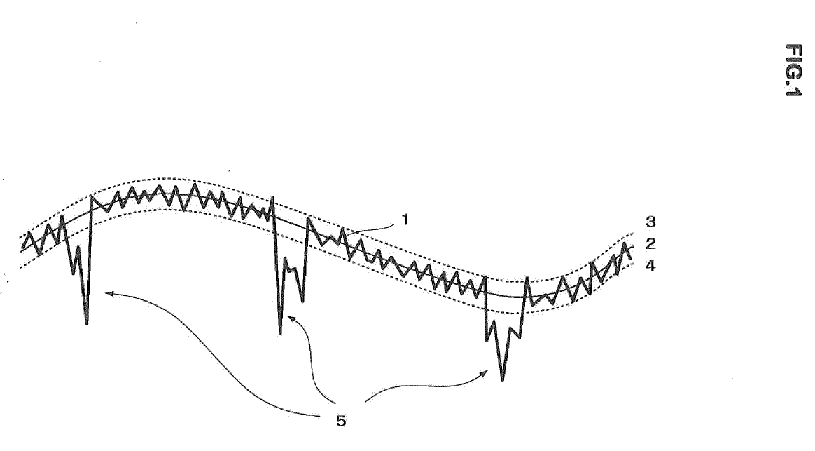

The amount of lubricant held on a steel surface in press forming (hereinafter referred to as “lubricant-holding ability”) is dependent on a sealing property provided by the steel surface and a stamping tool, and the total volume of dented portions on the surface. The sealing property provided by the steel surface and stamping tool depends on whether flat portions exist and, if so, the characteristics thereof. Generally, flat portions are defined with reference to a deviation from the centerline of the roughness profile of the steel surface. According to our knowledge, however, for a high strength steel sheet that is subjected to high contact pressure applied by a stamping tool, it is preferable that the deviation based on the filtered waviness curve be used as a definition for the flat portions. That is, as shown in FIG. 1 in which the horizontal axis denotes a distance measured along a direction of the surface and the vertical axis denotes a height of irregularity, if a roughness profile 1 has a portion having a deviation of ±2 μm from a filtered waviness curve 2 (i.e., a region in which the roughness profile 1 exists between a curve 3 “filtered waviness curve 2+2 μm” and a curve 4 “filtered waviness curve 2−2 μm”), the portion can be considered as a flat portion and the sealing property for holding the lubricant can be secured. Here, the filtered waviness curve is obtained by removing short periodic components from the roughness profile 1. The filtered waviness curve is measured in accordance with JIS B0601 and B0610-1987 and at a cut-off length of 0.8 mm or 2.5 mm.

The wavelength and amplitude of the filtered waviness curve (of the steel sheet) are not limited, however, the wavelength is preferably about 10 to 100 mm and the amplitude is 10 μm or less.

2) Presence of dented portions having a maximum depth of 10 μm or more and 50 μm or less from a filtered waviness curve: the average area of the dented portions is more than 0.01 mm² and 0.2 mm² or less

The dented portions of a steel sheet are also defined based on the filtered waviness curve. That is, the volume of a dented portion 5 (see FIG. 1), which is another factor for deciding a lubricant-holding ability, is determined by the maximum depth (of the dented portion 5) from the filtered waviness curve and the area of the dented portion 5.

The maximum depth of the dented portions from the filtered waviness curve is required to be in a range of 10 μm to 50 μm because if the maximum depth of the dented portions is less than 10 μm, the lubricant-holding ability is insufficient and if the maximum depth exceeds 50 μm, cracking may occur in press forming beginning at the dented portion. The average area of the dented portions is required to be over 0.01 mm² and 0.2 mm² or less because if the average area of the dented portions is 0.01 mm² or less, the lubricant-holding ability is insufficient and if the average area of the dented portions is over 0.2 mm², the sealing property for holding the lubricant between the steel sheet and the stamping tool, which is tightly pressed to the steel sheet, is deteriorated even in high-strength steel sheet and leads to a decrease in the lubricant-holding ability to an insufficient level. Note that the average area of the dented portions mentioned here is an average area that is clipped off by the dented portions from a surface of the filtered waviness curve of a steel sheet. It is preferable that the average area of the dented portions is 0.012 mm² or more and further preferably, 0.020 mm² or more.

3) Fraction of the total area of dented portions (relative to the area of the entire surface of the steel sheet): from 5% and more to less than 20%

To improve the galling-prevention properties, the fraction of the total area of dented portions that have the shape mentioned above is desired to be properly controlled. The fraction should be from 5% and more to less than 20%. If the fraction is less than 5%, the lubricant-holding ability is insufficient and if the fraction thereof is 20% or more, the sealing property for holding a lubricant in the dented portions decreases and this leads to a reduction in the lubricant-holding ability into insufficient degree.

Since dented portions having a maximum depth of more than 2 μm and less than 10 μm do not contribute to enhancement of the galling-prevention properties, such dented portions are assimilated to be flat portions. However, if the area fraction of such dented portions mentioned above exceeds 20%, the lubricant-holding ability of dented portions having a maximum depth of 10 μm or more and 50 μm or less may be suppressed. Therefore, it is preferable that the fraction of the total area of dented portions having a maximum depth of more than 2 μm and less than 10 μm (relative to the area of the entire surface of the steel sheet) be 20% or less.

As described above, if the flatness and characteristics of dented portions (depth, area, and distribution) are set in a proper range based on the filtered waviness curve, the surface of the steel sheet can maintain a high roughness and the ability to effectively hold a sufficient amount of lubricant.

Here, preferable examples of the high-strength steel sheets are described below. The surface texture mentioned above can be formed on all high-strength steel sheets, but if it is applied to the steel sheets having compositions or mechanical properties described below, a particular advantage can be provided.

(Chemical Component) (Hereinafter Denoted with Percentage by Mass)
C: 0.05% or more and 0.2% or less

To obtain a high-strength cold-rolled steel sheet having a sufficient tensile strength, it is very effective to have a C content of 0.05% or more. On the other hand, to secure an excellent spot weldability, the content of C is preferably 0.2% or less.

Si: 0.15% or more and 2.0% or less

To obtain a high-strength cold-rolled steel sheet having sufficient tensile strength, it is very effective to have a Si content of 0.15% or more. Furthermore, if the content of Si is 0.15% or more, galling-prevention properties are further improved markedly. This is because, according to our speculation, a silicon oxide, which is selectively oxidized at the surface of the steel sheet in annealing after cold rolling, can prevent metal transfer between a press stamping tool and the steel sheet. To further enhance this effect, the content of Si is preferably 0.6% or more. On the other hand, to ensure phosphatability, the content of Si is preferably 2.0% or less. Mn: 0.9% or more and 2.5% or less

To obtain a high-strength cold-rolled steel sheet having sufficient tensile strength, it is very effective to have a content of Mn being 0.9% or more. On the other hand, to secure excellent ductility which provides exceptional press-formability, the content of Mn is preferably 2.5% or less.

Al: 0.01% or more and 0.1% or less

Al is often used as a deoxidation element. For deoxidation, the content of Al is preferably 0.01% or more. On the other hand, if the content of Al exceeds 0.1%, the deoxidation effect becomes saturated. Therefore, it is preferable that the content of Al be 0.1% or less in view of the cost of adding Al.

N: 0.005% or less

For standard high-strength cold-rolled steel sheets, N is an impurity element and removed in steelmaking. To secure excellent ductility which provides exceptional press-formability, the content of N is preferably 0.005% or less.

The balance is preferably composed of Fe and inevitable impurities.

The following elements may be optionally added.

At least one element selected from Ti, Nb, and V: the content of each element is 0.01% or more and 0.1% or less

Ti, Nb, and V have an effect of increasing the tensile strength of steel sheets by being precipitated as carbide therein. To develop this function, the content of each element is preferably 0.01% or more. On the other hand, however, if the content of each element exceeds 0.1%, not only a saturation of the above effect but also an increase in cost is incurred.

At least one element selected from Cr and Mo: the content of each element is 0.1% or more and 1% or less.

Cr and Mo are elements that enhance quench hardening. To use these elements effectively, the content of each element is preferably 0.1% or more. On the other hand, to secure excellent ductility which provides exceptional press-formability, the content of each element is preferably 1% or less.

At least one element selected from Cu and Ni: the content of each element is 0.1% or more and 1% or less

Cu and Ni are elements for reinforcement for solution hardening and precipitation hardening. To develop these effects, the content of each element is preferably 0.1% or more. On the other hand, to secure excellent ductility which provides exceptional press-formability, the content of each element is preferably 1% or less.

### (Mechanical Properties)

Tensile strength (Hereinafter referred to as TS): preferably 590 MPa or more and 1,500 MPa or less.

A surface texture can be used to a high-strength cold-rolled steel sheet having a TS of 340 MPa or more without problem. In particular, in a high-strength cold-rolled steel sheet having a TS of 590 MPa or more, an effect of preventing galling is markedly improved. Furthermore, when the TS is 780 MPa or more, which is the most preferable case, the highest level of galling prevention that has been unachievable in the conventional art is achieved. The reason thereof is considered that because the strength of the steel material is increased, the surface texture of the steel sheet can be stably maintained in high-pressure press forming.

From the viewpoint of applicability, to fully satisfy the recent requirement for enhancement of the strength of mechanical parts used in automobiles and the like and for reducing the weight of such mechanical parts, it is preferable that the TS of the steel sheet be 590 MPa or more, and more preferably, 780 MPa or more.

Note that from the point of view of securing excellent ductility and weldability, it is preferable that the TS be 1,500 MPa or less.

### (Method of Manufacturing)

### (Preferable Conditions for Manufacturing)

Preferable conditions for manufacturing of a high-strength steel sheet are described below.

At first, a steel ingot is cast and then hot rolled and cold rolled. Composition of the steel ingot is preferably the same as the composition mentioned above. Then annealing is performed, and after annealing, rapid cooling such as quenching may preferably be performed for strengthening. The annealing may be box annealing or continuous annealing.

The heat treatment temperature and time in the continuous annealing are preferably from 750° C. to 890° C. and 10 sec to 500 sec and those in the box annealing are preferably from 650° C. to 750° C. and 1 hour to 30 hours, respectively. To achieve a high TS of 590 MPa or more, continuous annealing is preferably applied and the cooling rate from the above-mentioned heat treatment temperature to 300° C. or lower is preferably −100° C./sec or more.

An annealing gas preferably contains nitrogen as a main component and hydrogen with a volume percentage of 3% to 15% and has a dew point temperature of −20° C. or lower. This is for controlling the annealing gas in proper oxygen potential so that oxide of Si, Al, or the like (if their respective contents are within the above-mentioned range) is formed on a surface of the steel sheet. The resulting oxide having a high melting point can prevent a metal transfer between a stamping tool and the surface of the steel sheet in press forming. After the heat treatment (annealing), it is preferable that oxides of Mn, Fe, or the like having a low melting point be removed using hydrochloric acid or sulfuric acid. Here, the pickling time (immersion time) is preferably about 5 to 60 seconds. This is for preventing metal transfer between the stamping tool and stamped parts (steel sheets) due to the oxide having low melting point in press forming. Such an operation for removing the oxide can enhance the effect of the above-mentioned oxide of Si, Al, or the like, having a high melting point. Note that the temperature of a pickling bath is preferably in a range of about 40° C. to 90° C., which is typically used.

Even if surface treatments such as hot-dip galvanizing/galvannealing, electro galvanizing, and flash Ni-plating are performed, the effects of the surface (geometric) texture of the steel sheets can remain unchanged. However, the effect of prevention of the metal transfer by controlling the oxide formed on the surface of the steel sheet cannot be fully exhibited.

### (A Method of Forming a Surface Texture of a Steel Sheet)

The high-strength cold-rolled steel sheet can be manufactured by cold rolling and annealing a steel sheet after hot-rolling, having a composition corresponding to a required strength, as mentioned above. In cold rolling, or in temper rolling after annealing, which may include rapid cooling, the above-mentioned surface texture can be formed on the steel surface by controlling a rolling reduction rate and an elongation rate using a work roll having a desired surface texture thereon.

Specifically, the work roll with the surface texture having a maximum profile peak height Rp of 10 μm or more and 50 μm or less and a Kernrauhtiefe Rk of 10 μm or more is used. The steel sheet is rolled by the roll at a rolling reduction rate of 5% or more when rolled in cold rolling, and is rolled at an elongation rate of 0.10% or more when rolled in temper rolling. Hereinafter, the work roll with the above-mentioned surface texture is referred to as a surface-controlling work roll.

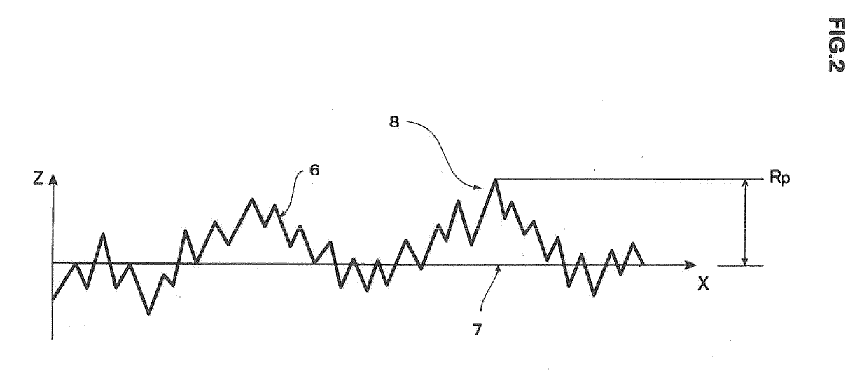

Here, Rp is measured in accordance with IS04287/1 as shown in a schematic view of FIG. 2. That is, an evaluation length of 2.5 mm, which is stipulated in JIS B0601-1982, is sampled from a roughness profile (filtered) 6. Here, the roughness profile (filtered) 6 is a curve that is obtained under the stipulation of JIS B0601-1982, from the roughness profile (steel surface profile) by removing a surface-waviness component having a longer wavelength than a predetermined wavelength of 0.8 mm using a phase-compensated high-pass filter. In FIG. 2, the X axis represents the distance along the measurement direction and the Z axis represents the height. Rp denotes the distance between a centerline 7 of the roughness profile 6 and a straight line being parallel to the centerline 7, which pass a highest point 8 of the roughness profile 6 within a sampling range. Rp denotes an essential index for forming the surface texture on the steel sheet. If Rp is less than 10 μm, a desired surface texture cannot be formed on a steel sheet. If Rp exceeds 50 μm, the depth of dented portions on the surface of the steel sheet becomes excessively large leading to deterioration of galling-prevention properties thereof. If Rp exceeds 50 μm, further, the lifetime of the work roll decreases.

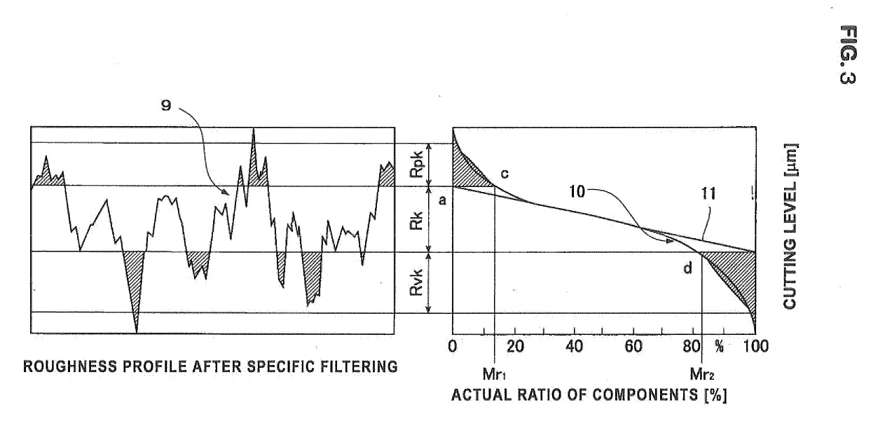

On the other hand, Rk is measured in accordance with German standard DIN4776-1990, which is similar to ISO13565, as shown in a schematic view of FIG. 3. A roughness profile 9 shown in FIG. 3 (left) is obtained by specific (Gaussian) filtering. Here, the horizontal axis represents the distance along the measurement direction and the vertical axis represents the height. With reference to the roughness profile 9, a frequency distribution ratio of each of the heights is calculated and a curve (bearing area curve 10) showing a value of integrated frequency distribution ratio (actual ratio of components) is obtained. This is shown in FIG. 3 (right). Here, the horizontal axis represents the actual ratio of components and the vertical axis represents the height of a cutting level. A line segment which has both ends on the load curve, having a range of 40% of the range of the entire bearing area curve 10 is selected so as to have the smallest gradient (not shown in FIG. 3). A line obtained in such area of the line segment having the smallest gradient is referred to as the minimum-gradient line 11. The point of interception of the minimum-gradient line 11 (extrapolated) and the vertical line corresponding to an actual ratio of 0% is referred to as “a” and the point of interception of the minimum-gradient line 11 (extrapolated) and the vertical line corresponding to an actual ratio of 100% is referred to as “b.” The height distance between “a” and “b” is referred to as Rk.

Rk is an essential index for controlling the lifetime of the roll. If Rk is less than 10 μm, the lifetime of the roll becomes short and the necessary surface texture of the steel sheet cannot be stably formed. Rk is preferably 30 μm or less.

The average roughness Ra of the work roll satisfying the above-mentioned condition falls within about 3 to 10 μm. This is, however, not a sufficient condition. As mentioned above, controlling of Rp and Rk is needed. The surface texture of the surface-controlling work roll can be formed by electric spark machining of the roll surface for example. In electric spark machining, it is preferable that the electric current for machining be about 3 to 10 A and the energizing time be about 10 to 200 μs.

Note that the surface texture of the work roll was measured using a Surfcom™570A (TOKYO SEIMITSU CO., LTD.) and Rp, Rk, and Ra were determined according to an instruction described in the manual of the apparatus.

When the desired surface texture is given to the steel sheet in cold rolling using the above-mentioned surface-controlling work roll, if a reverse type cold-rolling mill is used, at least one pass is performed with a rolling reduction rate of 5% or more, and if a tandem cold-rolling mill is used, at least one stand is performed with the same rate as mentioned above, by the roll. If a rolling reduction rate per pass or stand is less than 5%, it is difficult to satisfactorily form the surface texture on the steel sheet. If the rolling reduction rate per pass or stand by the surface-controlling roll is 10% or more, galling-prevention properties are significantly improved by the given surface texture. Therefore, the rolling reduction rate is preferably 10% or more.

In cold rolling, it is preferable that the last one or more than one passes or stands be rolled using the above-mentioned surface-controlling work roll. In particular, at the last pass or stand, it is preferable that rolling be performed under a rolling reduction rate of 5% or more, and preferably 10% or more.

The steel sheet that is cold-rolled using the above-mentioned surface-controlling work roll is preferably annealed under the above-mentioned suitable conditions. After annealing, a common temper rolling with an elongation rate of 0.1% to 3.0% may be performed. Here, surface treatments such as hot-dip galvanizing (or galvannealing), electro galvanizing, and flash Ni-plating may be performed before the temper rolling. Or, temper rolling may be conducted for as-annealed steel sheet. This is because, in the case that a surface texture is formed on a steel sheet, if a common temper rolling in which flat portions are mainly formed is performed, a negative effect on the surface texture of the steel sheet is significantly suppressed. To reduce the negative effect on the surface texture of the steel sheet furthermore, it is preferable that the average roughness Ra of the work roll used in the temper rolling be 2 μm or less.

On the other hand, when the temper rolling with the above-mentioned surface-controlling work roll is performed after annealing so as to form the desired surface texture on the steel sheet, the elongation rate is 0.10% or more. If the elongation rate is less than 0.10%, it is difficult to form a desired surface texture on a steel sheet. To secure an elongation of a steel sheet, the elongation rate is preferably 2% or less.

If temper rolling is performed, the desired surface texture for the steel sheet can be formed under a lower elongation rate (rolling reduction rate) than that of cold rolling. This is because, in a case of temper rolling, a strain stored in an annealed steel sheet has been released and this results in easy formation of the surface texture on the steel sheet. On the other hand, in a case of cold rolling, the strain due to cold rolling has accumulated in the steel sheet by the time the surface texture is formed. To release the strain so as to form a preferable surface texture and to maintain the strength of the steel sheet, the above-mentioned annealing conditions are preferably applied.

### EXAMPLES

### Example 1

Steel sheets 1 to 15 and 41 to 52 having a thickness of 1.2 mm and annealed were prepared in a laboratory. Compositions of the steel sheets 1 to 15 were varied within the following ranges:
C: 0.06% to 0.15%
Si: 0.6% to 1.5%
Mn: 1.2% to 2.3%
Al: 0.03% to 0.08%
N: 0.0045% or less
Ti: 0 (non-addition) to 0.04%

The annealing conditions were as follows (varied):
Temperature: 780° C. to 870° C.
Time: 60 to 400 sec
Ambient gas: hydrogen gas of 5% to 7% and nitrogen gas as a balance
Dew-point temperature of ambient gas: about −30° C.

The steel sheets 1 to 15 were annealed under the above-mentioned conditions and cooled to 300° C. or lower at the rate of 30° C./sec to 2,000° C./sec.

Compositions of the steel sheets 41 to 45 were as follows:
C: 0.02%
Si: 0.02%
Mn: 0.2%
Al: 0.05%
N: 0.0030%

The annealing conditions were as follows:
Temperature: 800° C.
Time: 120 sec
Ambient gas: hydrogen gas of 5% to 7% and nitrogen gas as a balance
Dew-point temperature of ambient gas: about −30° C.

The steel sheets 41 to 45 were annealed under the above-mentioned conditions and cooled to 300° C. or lower at a rate of about 30° C./sec. Compositions of the steel sheets 46 to 50 were as follows:
C: 0.15%
Si: 0.7%
Mn: 1.9%
Al: 0.03%
N: 0.0030%

The annealing conditions were as follows:
Temperature: 860° C.
Time: 300 sec
Ambient gas: hydrogen gas of 5% to 7% and nitrogen gas as a balance
Dew-point temperature of ambient gas: about −30° C.

The steel sheets 46 to 50 were annealed under the above-mentioned conditions and cooled to 300° C. or lower at a rate of about 2,000° C./sec. As for steel sheets 46 to 49, surface textures except for an average area of dented portion were controlled to be the same condition as far as possible.

After annealing, steel sheets 47 and 48 were washed (pickled) with a hydrochloric acid for about 30 sec and the resulting steel sheets were referred to as steel sheets 51 and 52, respectively.

Steel sheets 1 to 6, 8, 10, 44, 45, 47, and 48 were temper-rolled under a condition that an elongation rate is 0.10% or more and 1.0% or less using a work roll having an Rp of 10 Pn or more and 50 μm or less and an Rk of 10 μm or more and 30 μm or less. Steel sheets 7, 9, 11 to 15, 41 to 43, 46, 49, and 50 were temper-rolled under a condition that an elongation rate is 0.10% or more and 5.0% or less using a work roll having Rp of 5 μm or more and 80 μm or less and Rk of 5 μm or more and 45 μm or less.

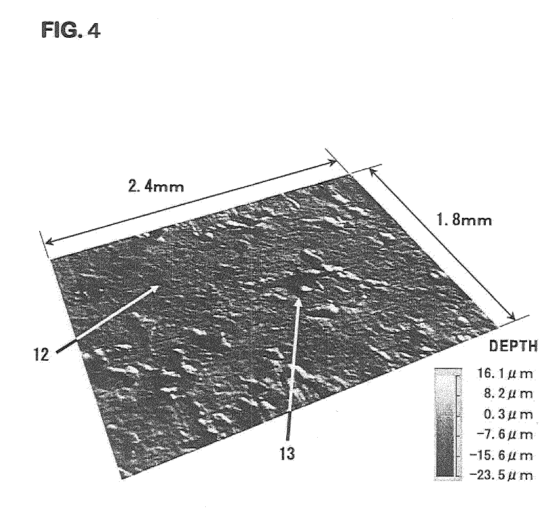

After temper rolling, JIS-5 test pieces were cut out from steel sheets along the vertical direction to the rolling direction and subjected to tensile tests for determining yield strength YS, tensile strength TS, and elongation El. Surfaces of temper-rolled steel sheets were observed under a scanning electron microscope with a 3-dimensional surface texture analyzer. On the basis of the observation results, surface textures of the steel sheets including the largest depth from a filtered waviness curve (of dented portions), an average area of dented portions, and the fraction of the total area of the dented portions. Furthermore, it was confirmed that, in areas of flat portions, which are areas except the dented portions, most areas of the steel sheets have a deviation of ±2 μm or less from a filtered waviness curve. (Specifically, a ratio of areas having a deviation of more than 2 μm and less than 10 μm from the filtered waviness curve relative to an area of the entire surface was 10% or less. However, for steel sheets 9, 13, and 15, a ratio of areas having a deviation of more than 2 μm and less than 10 μm from the filtered waviness curve and not forming the dented portions was 10% or less.) FIG. 4 is an example of a topographic image showing a surface profile observed under the scanning electron microscope. In FIG. 4, numerical numbers 12 and 13 are a flat area and a dented area, respectively.

Ra and Rmax were measured in accordance with JIS B0601 using the results obtained under the scanning electron microscope. Furthermore, Rv was measured using the Surfcom™570A (TOKYO SEIMITSU CO., LTD.). Here, Rv is a distance [μm] between the center-line and the deepest valley (the bottom thereof) on the roughness profile in a measured distance, as defined in Japanese Unexamined Patent Application Publication No. 9-118918.

Galling-prevention properties were evaluated by counting the number of sliding performed until a galling occurred. The sliding was performed under contact pressures such as 15 kgf/mm² (condition A), 30 kgf/mm² (condition B), and 50 kgf/mm² (condition C) using a stamping tool made of SKD11, which has the same shape as the flat-plate-sliding-device disclosed in Japanese Unexamined Patent Application Publication No. 2005-240148, and the sliding distance was 100 mm. The condition A is corresponding to a condition for pressing mild steel sheets and the conditions B and C are for pressing high-strength steel sheets. Note that if the number of sliding performances conducted under the condition B exceeds 50, it can be decided that defects are not generated substantially in actual press forming. If the number of sliding performances conducted until a galling occurs under the condition C is large, which is much more serious condition than the condition B, the galling-prevention properties thereof are more excellent and stable even if a material of stamping tools or a lubrication condition is varied. Therefore, a test piece, which can be subjected to lager number of sliding performances conducted until a galling occurs under the condition C, is more preferable.

Tables 1 and 2 show the results. Steel sheets 1 to 6, 8, 10, 47, 48, 51, and 52 have our surface textures. The number of sliding performances conducted until a galling occurs under the condition B exceeds 50. This shows that the steel sheets have excellent galling-prevention properties.

Furthermore, if the tensile strength of the steel sheets is 590 MPa or more (i.e., except steel sheet 10), sliding can be performed 20 times or more even under the condition C. This means such steel sheets have particularly excellent galling-prevention properties. Furthermore, if pickling is performed to enhance an effect of oxide formed on a surface thereof (steel sheets 51 and 52), the sliding can be performed 50 times or more under the condition C. This means the steel sheets have ultimately excellent galling-prevention properties.

According to the results of steel sheets 41 to 45, it is found that galling-prevention properties of mild steel sheets having TS of smaller than 340 MPa cannot be enhanced when the surface textures are formed on the steel sheets. Although the galling-prevention properties of the mild steel sheets having dented portions with rather smaller average-area than that of this disclosure can be enhanced more, still the properties cannot be enhanced under high contact pressure. This is considered to be caused by the low material strength, because the surface texture having properties described cannot be stably maintained during a formation under the high contact pressure. The reason also is considered to include a small content of Si and thereby an insufficient amount of oxide with a high melting point.

TABLE 1

| Steel | | | | | | | |
|---|---|---|---|---|---|---|---|
| sheet | Tensile properties | | | Surface texture of the steel sheet (1) | | | |
| No. | YS [MPa] | TS [MPa] | El [%] | Ra [μm] | Rmax [μm] | Rv [μm] | Note |
| 1 | 847 | 1129 | 14.2 | 8.7 | 45.5 | 40.6 | Example of the invention |
| 2 | 787 | 1050 | 15.2 | 4.3 | 19.4 | 26.2 | Example of the invention |
| 3 | 754 | 1005 | 15.9 | 6.0 | 29.8 | 40.2 | Example of the invention |
| 4 | 901 | 1202 | 13.3 | 4.5 | 18.9 | 25.6 | Example of the invention |
| 5 | 708 | 944 | 17.0 | 2.1 | 10.2 | 7.7 | Example of the invention |
| 6 | 876 | 1168 | 13.7 | 8.5 | 60.0 | 53.8 | Example of the invention |
| 7 | 901 | 1202 | 13.3 | 5.6 | 28.6 | 24.6 | Comparative example |
| 8 | 440 | 587 | 27.3 | 6.8 | 32.7 | 25.1 | Example of the invention |
| 9 | 562 | 750 | 21.3 | 2.8 | 15.1 | 13.9 | Comparative example |
| 10 | 326 | 435 | 36.8 | 6.6 | 32.0 | 25.5 | Example of the invention |
| 11 | 520 | 694 | 23.1 | 1.4 | 8.2 | 11.1 | Comparative example |
| 12 | 652 | 869 | 18.4 | 11.5 | 65.8 | 51.7 | Comparative example |
| 13 | 585 | 780 | 20.5 | 1.9 | 12.7 | 11.7 | Comparative example |
| 14 | 502 | 670 | 23.9 | 6.8 | 48.2 | 32.5 | Comparative example |
| 15 | 879 | 1173 | 13.6 | 1.7 | 7.2 | 6.6 | Comparative example |
| 41 | 169 | 273 | 57.5 | 7.8 | 10.9 | 9.1 | Comparative example |
| 42 | 169 | 273 | 57.5 | 16.0 | 18.9 | 22.4 | Comparative example |
| 43 | 169 | 273 | 57.5 | 13.2 | 17.2 | 17.0 | Comparative example |
| 44 | 169 | 273 | 57.5 | 8.8 | 10.7 | 12.1 | Comparative example |
| 45 | 169 | 273 | 57.5 | 17.9 | 24.5 | 20.6 | Comparative example |
| 46 | 1050 | 1252 | 10.1 | 10.3 | 13.9 | 14.3 | Comparative example |
| 47 | 1050 | 1252 | 10.1 | 8.5 | 10.0 | 10.5 | Example of the invention |
| 48 | 1050 | 1252 | 10.1 | 13.0 | 16.3 | 18.1 | Example of the invention |
| 49 | 1050 | 1252 | 10.1 | 11.4 | 13.0 | 15.3 | Comparative example |
| 50 | 1050 | 1252 | 10.1 | 10.8 | 13.3 | 12.6 | Comparative example |
| 51 | 1050 | 1252 | 10.1 | 8.5 | 10.0 | 10.5 | Example of the invention |
| 52 | 1050 | 1252 | 10.1 | 13.0 | 16.3 | 18.1 | Example of the invention |

TABLE 2

| | Surface texture Of the steel sheet (2) | | | | | | |
|---|---|---|---|---|---|---|---|
| Steel | Maximum depth | | | Number until occurrence of galling | | | |
| sheet | of dented | Average dented | Dented area | Condition A | Condition B | Condition C | |
| No. | portion [μm] | area [mm²] | fraction [%] | 15 kgf/mm² | 30 kgf/mm² | 50 kg/mm² | Note |
| 1 | 39.2 | 0.190 | 14.0 | >50 | >50 | 30 | Example of the invention |
| 2 | 24.0 | 0.071 | 12.5 | >50 | >50 | 25 | Example of the invention |
| 3 | 34.3 | 0.145 | 9.8 | >50 | >50 | 26 | Example of the invention |
| 4 | 20.7 | 0.053 | 15.4 | >50 | >50 | 40 | Example of the invention |
| 5 | 16.8 | 0.035 | 5.4 | >50 | >50 | 21 | Example of the invention |
| 6 | 37.0 | 0.169 | 18.2 | >50 | >50 | 34 | Example of the invention |
| 7 | 43.7 | 0.236 | 9.5 | 9 | 4 | 1 | Comparative example |
| 8 | 27.6 | 0.094 | 11.6 | >50 | >50 | 20 | Example of the invention |
| 9 | 9.3 | 0.011 | 17.9 | 23 | 7 | 1 | Comparative example |
| 10 | 29.2 | 0.105 | 17.3 | >50 | >50 | 10 | Example of the invention |
| 11 | 11.2 | 0.015 | 3.5 | 10 | 3 | 1 | Comparative example |
| 12 | 37.6 | 0.175 | 25.0 | 8 | 2 | 1 | Comparative example |
| 13 | 8.3 | 0.008 | 10.0 | 16 | 3 | 1 | Comparative example |
| 14 | 88.0 | 0.141 | 6.3 | 13 | 5(ruptured) | 1(ruptured) | Comparative example |
| 15 | 5.7 | 0.004 | 11.9 | 3 | 1 | 1 | Comparative example |
| 41 | 11.2 | 0.0002 | 6.1 | >50 | 3 | 1 | Comparative example |
| 42 | 22.8 | 0.005 | 5.8 | >50 | 2 | 1 | Comparative example |
| 43 | 18.9 | 0.008 | 10.2 | >50 | 1 | 1 | Comparative example |
| 44 | 12.6 | 0.015 | 13.1 | 7 • | 1 | 1 | Comparative example |
| 45 | 25.5 | 0.123 | 15.4 | 3 | 1 | 1 | Comparative example |
| 46 | 14.7 | 0.007 | 8.6 | 18 | 5 | 1 | Comparative example |
| 47 | 12.1 | 0.012 | 12.1 | >50 | >50 | 35 | Example of the invention |
| 48 | 18.6 | 0.058 | 15.3 | >50 | >50 | 40 | Example of the invention |
| 49 | 16.3 | 0.261 | 13.4 | 26 | 12 | 1 | Comparative example |
| 50 | 15.4 | 0.132 | 24.0 | 31 | 16 | 1 | Comparative example |
| 51 | 12.1 | 0.012 | 12.1 | >50 | >50 | >50 | Example of the invention |
| 52 | 18.6 | 0.058 | 15.3 | >50 | >50 | >50 | Example of the invention |

### Example 2

Hot rolled steel sheets having compositions shown in Table 3 were prepared in a laboratory. The hot rolled steel sheets were cold rolled by reverse type cold rolling under a condition, in which the last pass of rolling was performed at a rolling reduction rate shown in Table 3, using a surface-controlling work roll with Rp and Rk shown in Table 3. Then the resulting steel sheets were annealed under the condition shown in Table 4 and temper-rolled at an elongation rate of 0.05% or more and 0.7% or less resulting in steel sheets 16 to 26, and 61 having a thickness of 1.2 mm. The work roll used in cold rolling except the last pass and in temper rolling had Ra of 0.5 to 3.0 pin, Rp of 2 to 8 μm, and Rk of 3 to 5 μm.

After annealing, steel sheet 18 was washed with sulfuric acid for about 30 sec and referred to as steel sheet 62.

As similar to EXAMPLE 1, the resulting steel sheets were evaluated in tensile properties, surface texture of steel sheets, and galling-prevention properties. Total length of a rolled steel sheet manufactured before Rp of the work roll was reduced to 10 μm, was measured and used as an index of a lifetime of a roll. Note that the total length of a rolled steel sheet manufactured using a roll in available is 50 km, and a cost for treatment or maintenance frequency of a surface of a work roll can be judged to be similar to that of existing work rolls.

Tables 4 and 5 show the results. Steel sheets 16 to 18, 22 to 24, 26, and 62 have our surface textures. The number of sliding performances conducted until a galling occurs under the condition B exceeds 50. This shows that the steel sheets have excellent galling-prevention properties. The total length of a rolled steel sheet manufactured using a roll in available is 50 km or more. It shows that the lifetime of a roll is equal or superior to that of existing rolls. Conditions of the flat portions except the dented portions were the same as the condition of EXAMPLE 1.

TABLE 3

| | | | | | | | Conditions of cold rolling | | | | |
|---|---|---|---|---|---|---|---|---|---|---|---|
| Steel | | | | | | | Ra of work | Rp of work | Rk of work | Rolling | |
| sheet | Chemical composition [mass %] | | | | | | roll for the | roll for the | roll for the | reduction | |
| No. | C | Si | Mn | Al | N | Others | last pass [μm] | last pass [μm] | last pass [μm] | rate [%] | Note |
| 16 | 0.07 | 0.47 | 0.98 | 0.06 | 0.004 | — | 3.3 | 24.7 | 10.1 | 23.0 | Example of the invention |
| 17 | 0.15 | 0.65 | 1.33 | 0.06 | 0.003 | 0.02Ti | 4.3 | 25.9 | 15.4 | 9.5 | Example of the invention |
| 18 | 0.14 | 1.48 | 0.65 | 0.01 | 0.005 | 0.5Cr | 4.7 | 28.0 | 19.2 | 24.1 | Example of the invention |
| 19 | 0.13 | 1.11 | 1.63 | 0.05 | 0.002 | — | 3.2 | 9.2 | 13.0 | 21.8 | Comparative example |
| 20 | 0.15 | 0.10 | 1.29 | 0.01 | 0.003 | — | 7.4 | 44.3 | 16.4 | 3.9 | Comparative example |
| 21 | 0.05 | 1.12 | 1.52 | 0.02 | 0.002 | — | 5.6 | 33.7 | 7.1 | 22.9 | Comparative example |
| 22 | 0.08 | 0.94 | 0.88 | 0.02 | 0.003 | 0.3Mo | 4.8 | 34.0 | 19.1 | 17.7 | Example of the invention |
| 23 | 0.11 | 0.95 | 1.21 | 0.07 | 0.004 | 0.015Nb | 3.4 | 20.6 | 12.8 | 14.7 | Example of the invention |
| 24 | 0.05 | 0.57 | 1.47 | 0.03 | 0.003 | — | 3.7 | 22.1 | 14.4 | 13.6 | Example of the invention |
| 25 | 0.14 | 0.49 | 0.87 | 0.05 | 0.005 | — | 9.1 | 54.8 | 17.0 | 20.2 | Comparative example |
| 26 | 0.05 | 0.31 | 1.71 | 0.01 | 0.005 | — | 9.2 | 36.9 | 21.5 | 21.7 | Example of the invention |
| 61 | 0.002 | 0.01 | 0.12 | 0.03 | 0.003 | 0.06Ti | 5.3 | 30.1 | 12.0 | 18.5 | Comparative example |
| 62 | 0.14 | 1.48 | 0.65 | 0.01 | 0.005 | 0.5Cr | 4.7 | 28.0 | 19.2 | 24.1 | Example of the invention |

TABLE 4

| Steel | Annealing condition | | | | | | |
|---|---|---|---|---|---|---|---|
| sheet | Temperature | Time | Cooling rate | Tensile properties | | | |
| No. | [° C.] | [sec] | [° C./sec] | YS [MPa] | TS [MPa] | El [%] | Note |
| 16 | 819 | 178 | >1000 | 526 | 701 | 22.8 | Example of the invention |
| 17 | 812 | 151 | 30 | 476 | 634 | 25.2 | Example of the invention |
| 18 | 754 | 144 | >1000 | 895 | 1193 | 13.4 | Example of the invention |
| 19 | 841 | 393 | >1000 | 660 | 880 | 18.2 | Comparative example |
| 20 | 752 | 374 | 15 | 418 | 557 | 28.7 | Comparative example |
| 21 | 852 | 112 | 20 | 332 | 442 | 36.2 | Comparative example |
| 22 | 680 | 24 hr | <1 | 355 | 474 | 33.8 | Example of the invention |
| 23 | 796 | 30 | >1000 | 742 | 989 | 16.2 | Example of the invention |
| 24 | 857 | 146 | 30 | 381 | 508 | 31.5 | Example of the invention |
| 25 | 802 | 259 | 30 | 412 | 549 | 29.1 | Comparative example |
| 26 | 767 | 298 | 120 | 407 | 543 | 29.5 | Example of the invention |
| 61 | 830 | 120 | 15 | 145 | 265 | 55.4 | Comparative example |
| 62 | 754 | 144 | >1000 | 895 | 1193 | 13.4 | Example of the invention |

TABLE 5

| | Surface texture of the steel sheet | | | | | | | |
|---|---|---|---|---|---|---|---|---|
| Steel | Maximum depth | | | Number until occurrence of galling | | | Lifetime | |
| sheet | of dented | Average dented | Dented area | Condition A | Condition B | Condition C | of a roll | |
| No. | portion [μm] | area [mm²] | fraction [%] | 15 kgf/mm² | 30 kgf/mm² | 50 kgf/mm² | [km] | Note |
| 16 | 15.8 | 0.012 | 14.4 | >50 | >50 | 15 | 50 | Example of the invention |
| 17 | 17.3 | 0.037 | 19.0 | >50 | >50 | 25 | 77 | Example of the invention |
| 18 | 20.0 | 0.049 | 13.1 | >50 | >50 | 42 | 96 | Example of the invention |
| 19 | 6.3 | 0.031 | 3.5 | 8 | 1 | 1 | 60 | Comparative example |
| 20 | 4.2 | 0.005 | 9.5 | 16 | 1 | 1 | 82 | Comparative example |
| 21 | 8.5 | 0.165 | 17.3 | 25 | 8 | 1 | 21 | Comparative example |
| 22 | 32.4 | 0.177 | 10.9 | >50 | >50 | 13 | 96 | Example of the invention |
| 23 | 11.6 | 0.017 | 10.0 | >50 | >50 | 38 | 64 | Example of the invention |
| 24 | 11.9 | 0.018 | 19.2 | >50 | >50 | 12 | 72 | Example of the invention |
| 25 | 66.0 | 0.185 | 11.9 | 5 | 2(ruptured) | 1(ruptured) | 15 | Comparative example |
| 26 | 16.1 | 0.032 | 18.5 | >50 | >50 | 8 | 108 | Example of the invention |
| 61 | 15.4 | 0.025 | 16.7 | 12 | 1 | 1 | 200 | Comparative example |
| 62 | 20.0 | 0.049 | 13.1 | >50 | >50 | >50 | 96 | Example of the invention |

### Example 3

Steel sheets 27 to 37, and 71 to 77 having compositions shown in Table 5 and a thickness of 1.2 mm and annealed under the conditions shown in Table 5 were prepared in a laboratory. Some of the steel sheets were additionally given surface treatments shown in Table 6. Note that steel sheet 73 was prepared by pickling steel sheet 31 with hydrochloric acid for about 30 sec after annealing, and steel sheet 74 was prepared by conducting electro galvanizing to steel sheet 31.

Each of the steel sheets was temper-rolled under the condition shown in Table 6. As similar to EXAMPLE 2, the resulting steel sheets were evaluated in tensile properties, surface texture of steel sheets, galling-prevention properties, and a lifetime of a roll.

Table 7 shows the results. Steel sheets 27, 28, 31, 32, 35 to 37, 71 to 75, and 77 have our surface textures. The number of sliding performances conducted until a galling occurs under the condition B exceeds 50. This shows that the steel sheets have excellent galling-prevention properties. The total length of a rolled steel sheet manufactured using a roll in available is 75 km or more. It shows that the lifetime of a roll is equal or superior to that of existing rolls.

Although steel sheet 32 contains carbon less than the above-mentioned preferable amount, strength thereof can be secured by rapid cooling at the rate of 1,000° C./s or more resulting in preferable galling-prevention properties, for as much carbon as the example. On the other hand, a strength of steel sheet 34 was slightly decreased because the steel sheet 34 was box-annealed and rapid cooling could not be performed after annealing. Therefore, the number of sliding performance under condition C could not achieve the highest level. Furthermore, steel sheet 77 had substantially the same tensile properties and surface texture as the steel sheet 27, using the same toll as used in temper rolling for steel sheet 27. The steel sheet 77 could, however, achieve to the substantially highest level of galling-prevention properties because a content of Si therein was high so as to reduce the number of occurrence of galling generated under the condition C. Conditions of the flat portions except the dented portions were the same as the condition in EXAMPLE 1.

TABLE 6

| Steel | | | | | | | Annealing condition | | | | |
|---|---|---|---|---|---|---|---|---|---|---|---|
| sheet | Chemical composition [mass %] | | | | | | Temperature | Time | Cooling rate | Surface | |
| No. | C | Si | Mn | Al | N | Others | [° C.] | [sec] | [° C./sec] | treatments | Note |
| 27 | 0.05 | 0.17 | 0.97 | 0.07 | 0.003 | 0.065Ti | 792 | 243 | >1000 | — | Example of the invention |
| 28 | 0.10 | 0.57 | 1.69 | 0.03 | 0.003 | 0.15Cr | 764 | 257 | 25 | — | Example of the invention |
| 29 | 0.09 | 0.38 | 1.70 | 0.06 | 0.005 | — | 839 | 288 | >1000 | — | Comparative example |
| 30 | 0.08 | 0.78 | 1.58 | 0.03 | 0.003 | — | 780 | 65 | >1000 | — | Comparative example |
| 31 | 0.15 | 1.39 | 1.38 | 0.01 | 0.004 | — | 763 | 165 | >1000 | — | Example of the invention |
| 32 | 0.03 | 0.40 | 1.36 | 0.04 | 0.004 | — | 806 | 81 | >1000 | — | Example of the invention |
| 33 | 0.08 | 0.17 | 0.89 | 0.03 | 0.004 | — | 841 | 334 | 15 | — | Comparative example |
| 34 | 0.14 | 1.29 | 1.79 | 0.06 | 0.004 | — | 780 | 166 | >1000 | — | Comparative example |
| 35 | 0.09 | 0.16 | 1.91 | 0.02 | 0.005 | — | 720 | 3 hr | 20° C./hr | — | Example of the invention |
| 36 | 0.07 | 0.17 | 1.06 | 0.02 | 0.003 | 0.1Mo | 816 | 407 | 500 | — | Example of the invention |
| 37 | 0.06 | 1.46 | 1.27 | 0.06 | 0.005 | 0.045Nb | 857 | 109 | 120 | — | Example of the invention |
| 71 | 0.08 | 0.45 | 1.65 | 0.04 | 0.004 | 0.05V | 781 | 230 | >1000 | — | Example of the invention |
| 72 | 0.14 | 1.25 | 1.54 | 0.02 | 0.003 | 0.3Cu, 0.15Ni | 830 | 250 | >1000 | — | Example of the invention |
| 73 | 0.15 | 1.39 | 1.38 | 0.01 | 0.004 | — | 763 | 165 | >1000 | washed with | Example of the invention |
| | | | | | | | | | | hydrochloric acid | |
| 74 | 0.15 | 1.39 | 1.38 | 0.01 | 0.004 | — | 763 | 165 | >1000 | electro galvanized | Example of the invention |
| 75 | 0.09 | 0.21 | 2.45 | 0.07 | 0.004 | — | 810 | 60 | 30 | hot-dip galvannealed | Example of the invention |
| 76 | 0.001 | 0.05 | 0.12 | 0.04 | 0.002 | 0.02Ti, 0.02Nb | 845 | 115 | 30 | — | Comparative example |
| 77 | 0.06 | 0.75 | 0.97 | 0.07 | 0.003 | 0.06Ti | 830 | 165 | >1000 | — | Example of the invention |

TABLE 7

| Steel | Condition of temper rolling | | | | | | | |
|---|---|---|---|---|---|---|---|---|
| sheet | Ra of work | Rp of work | Rk of work | Elongation | Tensile properties | | | |
| No. | roll [μm] | roll [μm²] | roll [μm] | rate [%] | YS [MPa] | TS [MPa] | El [%] | Note |
| 27 | 9.6 | 45.2 | 27.8 | 0.83 | 633 | 844 | 19.0 | Example of the invention |
| 28 | 7.0 | 41.8 | 14.9 | 0.29 | 332 | 443 | 36.1 | Example of the invention |
| 29 | 3.1 | 5.0 | 21.0 | 0.58 | 738 | 984 | 16.3 | Comparative example |
| 30 | 4.4 | 26.6 | 18.1 | 0.06 | 745 | 993 | 16.1 | Comparative example |
| 31 | 5.3 | 31.8 | 21.6 | 0.23 | 930 | 1239 | 12.9 | Example of the invention |
| 32 | 5.0 | 30.0 | 15.5 | 0.14 | 842 | 1122 | 14.3 | Example of the invention |
| 33 | 2.8 | 16.5 | 4.9 | 0.53 | 341 | 455 | 35.1 | Comparative example |
| 34 | 8.7 | 52.2 | 22.6 | 0.14 | 920 | 1227 | 13.0 | Comparative example |
| 35 | 4.9 | 29.5 | 14.9 | 0.60 | 268 | 358 | 44.7 | Example of the invention |
| 36 | 3.4 | 10.6 | 12.3 | 0.18 | 667 | 889 | 18.0 | Example of the invention |
| 37 | 7.0 | 42.0 | 17.7 | 0.50 | 666 | 888 | 18.0 | Example of the invention |
| 71 | 4.5 | 22.5 | 12.3 | 0.21 | 479 | 798 | 24.1 | Example of the invention |
| 72 | 3.4 | 16.1 | 16.4 | 0.32 | 750 | 1250 | 12.5 | Example of the invention |
| 73 | 5.3 | 31.8 | 21.6 | 0.23 | 930 | 1239 | 12.9 | Example of the invention |
| 74 | 5.3 | 31.8 | 21.6 | 0.23 | 930 | 1239 | 12.9 | Example of the invention |
| 75 | 4.3 | 14.3 | 12.3 | 0.27 | 594 | 990 | 15.6 | Example of the invention |
| 76 | 5.5 | 12.1 | 14.5 | 0.85 | 155 | 272 | 54.4 | Comparative example |
| 76 | 9.6 | 45.2 | 27.8 | 0.45 | 560 | 832 | 20.5 | Example of the invention |

TABLE 8

| | Surface texture of the steel sheet | | | | | | | |
|---|---|---|---|---|---|---|---|---|
| Steel | Maximum depth | | | Number until occurrence of galling | | | Lifetime | |
| sheet | of dented | Average dented | Dented area | Condition A | Condition B | Condition C | of a roll | |
| No. | portion [μm] | area [mm²] | fraction [%] | 15 kgf/mm² | 30 kgf/mm² | 50 kgf/mm² | [km] | Note |
| 27 | 14.3 | 0.025 | 12.8 | >50 | >50 | 24 | 139 | Example of the invention |
| 28 | 18.6 | 0.055 | 14.8 | >50 | >50 | 8 | 75 | Example of the invention |
| 29 | 8.9 | 0.015 | 14.6 | 12 | 5 | 1 | 65 | Comparative example |
| 30 | 4.2 | 0.008 | 3.2 | 6 | 1 | 1 | 90 | Comparative example |
| 31 | 12.9 | 0.020 | 8.5 | >50 | >50 | 36 | 108 | Example of the invention |
| 32 | 19.5 | 0.065 | 11.5 | >50 | >50 | 22 | 78 | Example of the invention |
| 33 | 6.9 | 0.047 | 6.4 | 14 | 2 | 1 | 24 | Comparative example |
| 34 | 86.0 | 0.075 | 9.9 | 3 | 1(ruptured) | 1(ruptured) | 16 | Comparative example |
| 35 | 44.3 | 0.158 | 7.3 | >50 | >50 | 4 | 75 | Example of the invention |
| 36 | 23.2 | 0.067 | 7.9 | >50 | >50 | 24 | 99 | Example of the invention |
| 37 | 10.0 | 0.012 | 6.9 | >50 | >50 | 43 | 88 | Example of the invention |
| 71 | 13.3 | 0.023 | 6.3 | >50 | >50 | 27 | 81 | Example of the invention |
| 72 | 12.5 | 0.042 | 11.4 | >50 | >50 | 42 | 83 | Example of the invention |
| 73 | 12.9 | 0.020 | 8.5 | >50 | >50 | >50 | 108 | Example of the invention |
| 74 | 12.9 | 0.020 | 8.5 | >50 | >50 | 23 | 108 | Example of the invention |
| 75 | 32.5 | 0.254 | 14.2 | >50 | >50 | 25 | 83 | Example of the invention |
| 76 | 14.1 | 0.025 | 12.3 | 19 | 1 | 1 | 150 | Comparative example |
| 77 | 14.2 | 0.021 | 11.5 | >50 | >50 | 45 | 150 | Example of the invention |

### INDUSTRIAL APPLICABILITY

A high-strength cold-rolled steel sheet with a tensile strength of 340 MPa or more, which can certainly prevent occurrence of galling even if a large number of the steel sheets are continuously press-formed, can be manufactured. If a high-strength cold-rolled steel sheet is used, fracture of a stamping tool or generation of forming defects can be prevented during press forming, and a lifetime of a roll used in cold or temper rolling for manufacturing the high-strength cold-rolled steel sheet can be longer. Our steel sheets can show their effect more significantly when applied to a high-strength cold-rolled steel sheet having a tensile strength of 780 MPa or more.

1. A high-strength cold-rolled steel sheet having a surface texture thereon comprising:
a flat area in which a roughness profile has a deviation of ±2 μm or less from a filtered waviness curve; and
a dented portion having a maximum depth between 10 μm and 50 μm from the filtered waviness curve,
wherein an average area of the dented portions is more than 0.01 mm² and 0.2 mm² or less, and an area fraction of the dented portion is 5% or more and less than 20%.

2. A method of manufacturing a high-strength cold-rolled steel sheet comprising the steps of:
cold-rolling a steel sheet after hot rolling at a rolling reduction rate of 5% or more with a work roll having on a surface of the work roll a maximum profile peak height Rp of 10 μm or more and 50 μm or less and Kernrauhtiefe (core roughness depth) Rk of 10 μm or more: and
annealing a resulting cold-rolled steel sheet.

3. A method of manufacturing a high-strength cold-rolled steel sheet comprising the steps of:
cold-rolling a steel sheet after hot rolling;
annealing a resulting cold rolled steel sheet, and after annealing, temper rolling at an elongation rate of 0.10% or more with a work roll having on a surface of the work roll a maximum profile peak height Rp of 10 μm or more and 50 μm or less and Kernrauhtiefe Rk of 10 μm or more.
